(19) United States
(12) Patent Application Publication
(10) Pub. No.: US 2011/0052121 A1
(43) Pub. Date: Mar. 3, 2011

(54) FIBER BALL LENS APPARATUS AND METHOD

(75) Inventor: Wenxin Zheng, Ellicott City, MD (US)

(73) Assignee: AFL TELECOMMUNICATIONS LLC, Spartanburg, SC (US)

(21) Appl. No.: 12/810,117

(22) PCT Filed: Jan. 7, 2010
(86) PCT No.: PCT/US10/20299

§ 371 Date: Jun. 22, 2010

Related U.S. Application Data
(60) Provisional application No. 61/143,453, filed on Jan. 9, 2009.
(60) Provisional application No. 61/251,441, filed on Oct. 14, 2009.

(51) Int. Cl. G02B 6/32; B29D 11/00

(52) U.S. Cl. 385/35; 264/1.1; 425/112

(57) ABSTRACT

A method for producing a ball lens including determining a feed length of optical fiber based on a target ball lens diameter; providing heat energy to a heating zone; moving, at a predetermined speed, one of the optical fiber and the heating zone so that the end of the optical enters the heating zone to heat the end of the optical fiber; and stopping the heating of the end of the optical fiber when the amount of moving the one of the optical fiber and the heating zone equals the determined feed length.

### CROSS-REFERENCE TO RELATED APPLICATIONS

This application claims the benefit of U.S. Provisional Patent Application No. 61/143,453 filed on Jan. 9, 2009 and U.S. Provisional Patent Application No. 61/251,441 filed on Oct. 14, 2009 in the U.S. Patent and Trademark Office, the disclosures of which are incorporated herein in their entirety by reference.

### BACKGROUND OF THE INVENTION

### 1. Field of the Invention

Methods consistent with the present invention relate to a process for making ball lenses on optical fibers. Ball lenses may be used with optical fibers to aid in focusing light emanating from an optical fiber, coupling light between adjacent optical fibers, and to reduce the precision required when coupling a free space laser and an optical fiber. This results in ball lenses of a non-homogenous structure exhibiting poor focus control. Accordingly, the methods of manufacturing ball lenses in the related art are not capable of controlling the manufacture of ball lenses with precision and produce ball lenses exhibiting inferior performance.

Thus, there is a need for an improved ball lens method for manufacturing a ball lens and an improved ball lens device having a homogenous construction.

### SUMMARY OF THE INVENTION

An aspect of the invention is to provide an apparatus for coupling a free laser and an optical fiber that requires less precision in alignment and exhibits improved thermal characteristics.

In accordance with an aspect of the present invention, a method for forming a ball lens including determining a feed length of optical fiber based on a target ball lens diameter; providing heat energy to a heating zone; moving, at a predetermined speed, one of the optical fiber and the heating zone so that the end of the optical enters the heating zone to heat the end of the optical fiber; and stopping the heating of the end of the optical fiber when the amount of moving the one of the optical fiber and the heating zone equals the determined feed length.

The predetermined speed may be determined based on the amount of heat energy provided and the diameter of the optical fiber from which the ball lens is formed. The heating of the optical fiber may be stopped by shutting off the heat energy or by removing the optical fiber from the heating zone.

The method may also include rotating the optical fiber during the heating of the end of the optical fiber.

In accordance with another aspect of the present invention, an apparatus is provided that include an optical fiber heating apparatus that provides heat energy and conveys an optical fiber into a heating zone heated by the heat energy; a parameter determination unit that determines a feed length of optical fiber based on a target ball lens diameter; an optical fiber heating apparatus controller that controls the optical fiber heating apparatus to heat the optical fiber and convey the optical fiber the determined feed length.

The optical fiber may be conveyed into the heating zone by moving the optical fiber into a stationary heating zone or by moving heating zone onto a stationary optical fiber. Alternatively, the optical fiber may be conveyed into the heating zone by a combination of movement of both the optical fiber and the heating zone.

The heating apparatus may also be configured to rotate the optical fiber about an optical axis of the optical fiber during the heating of the optical fiber.

The heating apparatus may also be configured to stop the heat energy when the optical fiber is conveyed the determined feed length.

In accordance with an aspect of the present invention, a method for forming a ball lens including providing a coreless optical fiber and a second optical fiber different from the coreless optical fiber; splicing the coreless optical fiber to the second optical fiber to form a spliced optical fiber; severing the spliced optical fiber in a portion of the coreless optical fiber at a predetermine distance from a splice point of the spliced optical fiber; determining a feed length of the spliced optical fiber based on a target ball lens diameter; providing heat energy to a heating zone; moving, at a predetermined speed, one of the spliced optical fiber and the heating zone so that the coreless end of the spliced optical fiber enters the heating zone to heat the end of the spliced optical fiber; stopping the heating of the end of the spliced optical fiber when the amount of moving the one of the spliced optical fiber and the heating zone equals the determined feed length.

The method may also determine the predetermined speed based on an amount of heat energy provided and a diameter of the spliced optical fiber.

It is an aspect of the present invention that the heat energy applied to the spliced optical fiber melts the spliced optical fiber to form a molten ball.

The method may stop the heating by either shutting off the heat energy or by removing the optical fiber from the heating zone.

The method may also include rotating the optical fiber during the heating of the end of the spliced optical fiber.

In accordance with another aspect of the present invention, an optical fiber having a ball lens is provided including a spliced optical fiber including a coreless optical fiber spliced to a second optical fiber; a ball lens attached to the coreless optical fiber, wherein the ball lens is formed of the same material as the coreless optical fiber. The second optical fiber may have a core.

### BRIEF DESCRIPTION OF THE DRAWINGS

The above and/or other aspects of the invention will become apparent and more readily appreciated from the following description of the exemplary embodiments, taken in conjunction with the accompanying drawings in which:

FIG. 1 shows an example of a method for forming a ball lens on an optical fiber;

FIG. 2 shows an example of another method for forming a ball lens on an optical fiber;

FIG. 3 shows an apparatus for forming a ball lens on an optical fiber;

FIG. 4 shows an apparatus for forming a ball lens an optical fiber formed by splicing two different optical fiber structures;

FIG. 5 shows an apparatus for forming a ball lens and the effects of gravity on the ball lens being formed;

FIG. 6 shows an apparatus for forming a ball lens and the effects of gravity on a spliced optical fiber;

FIG. 7 shows an apparatus for forming a ball lens while rotating the optical fiber;

FIG. 8 shows an apparatus for forming a ball lens while rotating the optical fiber;

FIG. 9 shows an apparatus for forming a ball lens on a vertically positioned optical fiber;

FIG. 10 shows an apparatus for forming a ball lens on a vertically positioned optical fiber using a laser heat source;

FIG. 11 shows an apparatus for forming a ball lens using a filament as a heat source;

FIG. 12 shows an apparatus for forming a ball lens on a vertically positioned optical fiber using a laser heat source by moving the laser heat source;

FIG. 13 shows a general configuration apparatus for forming a ball lens on an optical fiber;

FIG. 14 shows a method for forming a ball lens on an optical fiber;

FIG. 15 shows another method for forming a ball lens on an optical fiber;

FIG. 16 shows a cross section of an optical fiber;

FIG. 17 shows another method of forming a ball lens on an optical fiber.

### DETAILED DESCRIPTION OF THE EXEMPLARY EMBODIMENTS

Hereinafter the exemplary embodiments of the present invention will be described in detail with reference to the accompanying drawings.

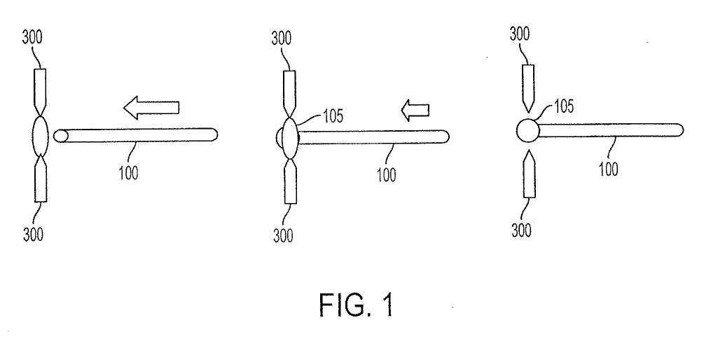

The first exemplary embodiment of the present invention provides a method of forming a ball lens 105 on an optical fiber 100. Generally, according to this exemplary embodiment, a ball lens 105 is formed on an optical fiber 100 by moving an end of the optical fiber 100 in relation to a heat source. As shown in FIG. 1, the heat source may comprise an arc discharge generated by a pair of electrodes 300. In order to form a ball lens 105 on the optical fiber 100, the heat source melts a portion of the end of the optical fiber 100. When the portion of the optical fiber 100 is melted into a liquid form, the surface tension of the liquid forms a ball of melted optical fiber material at the end of the optical fiber 100. Consequently, the heat source should be capable of generating temperatures within the optical fiber that exceed the melting temperature of the material or materials forming the optical fiber 100. If the optical fiber 100 is horizontal, the optical fiber 100 may be rotated to minimize gravitation effects on ball lens formation.

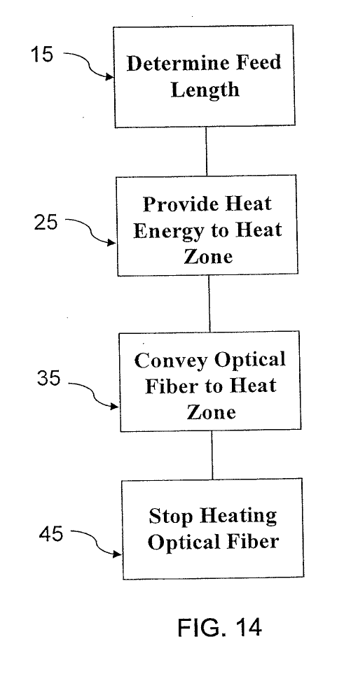

A method for making a ball lens according to an exemplary embodiment of the present invention is shown in FIG. 14. The amount of fiber required to make a desired ball lens size is determined as an optical fiber feed length in operation 15. The length of fiber to be melted may be determined based on the desired ball lens size and the diameter of the optical fiber 100. The volume of the ball lens and volume of a certain length of fiber may be determined using equations (1) and (2) below:

Fiber volume=πr²L (1)

Ball Lens volume=(4/3)πR³ (2)

where:

r—optical fiber radius

R—ball lens radius

L—length of optical fiber

Accordingly, the length of fiber L required to make a ball lens having a diameter D may be determined using equation (3):

L=2D³/3d² (3)

After determining the feed length of the optical fiber required to make a ball lens of a certain size, heat energy is provided to a heating zone in operation 25. After the heating zone is generated, the optical fiber is conveyed to the heating zone in operation 35. The heat energy heats the end of the optical fiber as it enters the heating zone to melt the optical fiber. The rate of conveying the optical fiber is determined based on the amount of heat energy, the thermal properties of the optical fiber and the size of the optical fiber. Generally, higher heat energy will enable faster conveyance rates and larger optical fibers will require lower conveyance rates. The conveying of the optical fiber may be performed by moving the optical fiber toward a stationary heating zone, or alternatively, moving the heating zone toward a stationary optical fiber. After the amount of conveyance meets the determined feed length, the heating is stopped in operation 45.

In one example, an optical fiber having a diameter of 125 μm was used to make a ball lens having a diameter of 370 μm. The total feeding length of the optical fiber was 2100 μm. The fiber was conveyed at a speed of about 70 μm per second with a rotation of about 6 degrees per second.

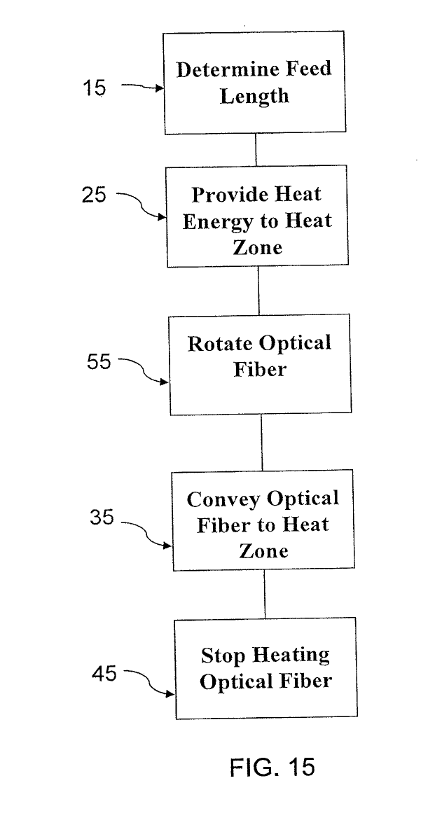

A method of forming a ball lens according to another exemplary embodiment is shown in FIG. 15. In the case where the optical fiber is disposed in a horizontal position, gravity may case the molten ball to sag or bend downward. If the ball lens is to be used in an application where such an effect is undesirable, the ball lens may be made using the method shown in FIG. 15 to reduce or eliminate the effects due to gravity. This method is substantially similar to the method as described above with reference to FIG. 14. However, to reduce the effects of gravity during the heating process, the optical fiber is rotated in operation 55. The rotation continues during the conveying of the optical fiber into the heating zone and may continue until after the heating has ceased.

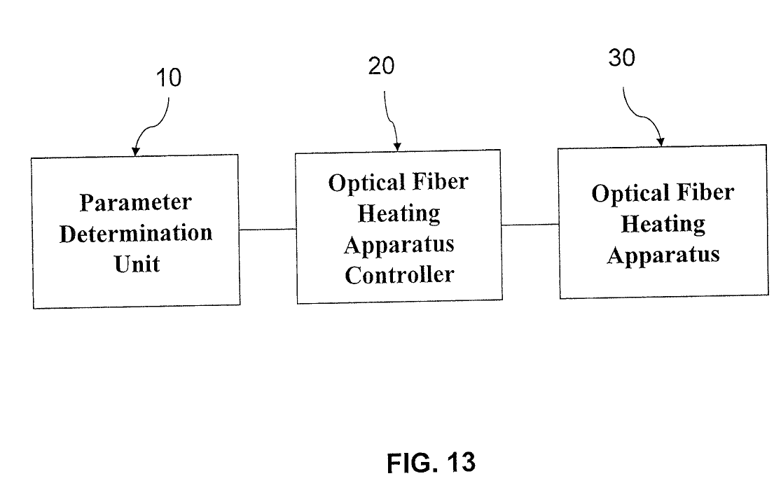

FIG. 13 is an example of an apparatus for forming a ball lens on an optical fiber 100. Generally, the apparatus includes an optical fiber heating apparatus 30 that provides heat energy and conveys an optical fiber 100 into a heating zone heated by the heat energy. The apparatus also includes a parameter determination unit 10 that determines a feed length of optical fiber based on a target ball lens diameter. The feed length may be set manually or determined in accord with any of the methods described herein. The apparatus also includes an optical fiber heating apparatus controller 20 that controls the optical fiber heating apparatus 30 to heat the optical fiber 100 and convey the optical fiber the determined feed length.

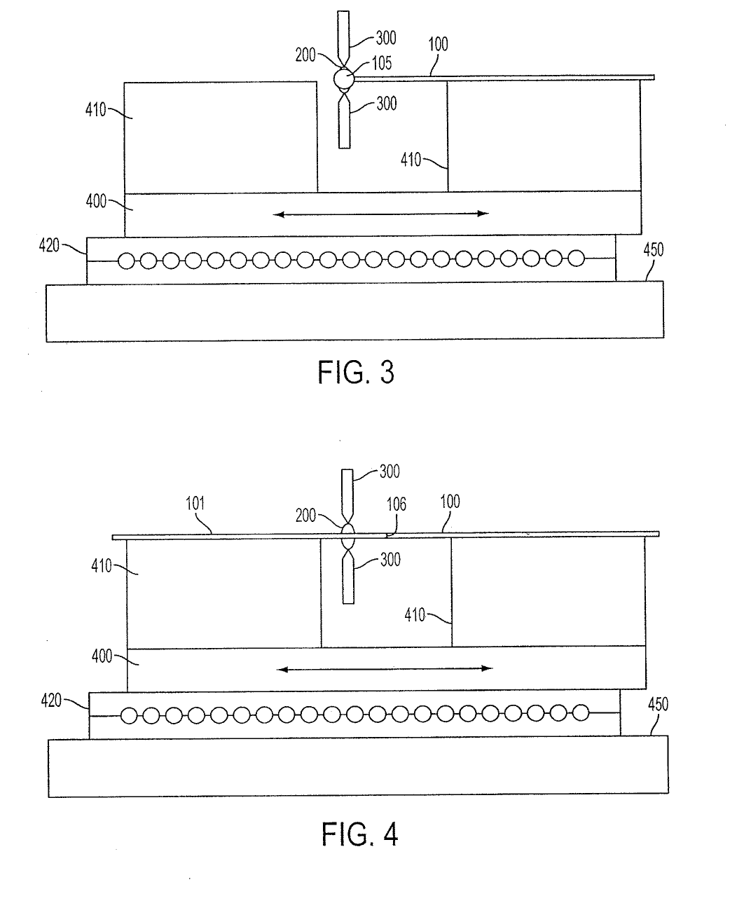

FIG. 3 an example of an apparatus capable of performing the method outlined above. As shown in FIG. 3, the method of forming a ball lens 105 on an optical fiber 100 may include heating the optical fiber 100 by moving the optical fiber 100 along its optical axis to heat an end of the optical fiber 100, such as by an arc discharge 200 from a pair of fixed electrodes 300 disposed on opposite sides of the optical fiber 100. For example, when the end of the optical fiber 100 enters the heat source, i.e., arc discharge 200, a portion of the end of the optical fiber 100 is melted into a liquid. As a result of the surface tension of the liquid, a ball is formed on the end of the optical fiber 100. When the ball cools and solidifies, a ball lens 105 is formed on the end of the optical fiber 100.

In the apparatus shown in FIG. 3, a clamp 410 is used to clamp the optical fiber 100 on one side of the electrodes 300. The clamp 410 is affixed to a movable translation stage 400. The movable translation stage 400 is mounted onto a bearing 420 which allows motion relative to a base 450. If the electrodes 300 are fixed to the base 450, the translation stage thereby moves the end of the optical fiber 100 adjacent to the electrodes 300 and through the heating field of the arc discharge 200 generated by the electrodes 300.

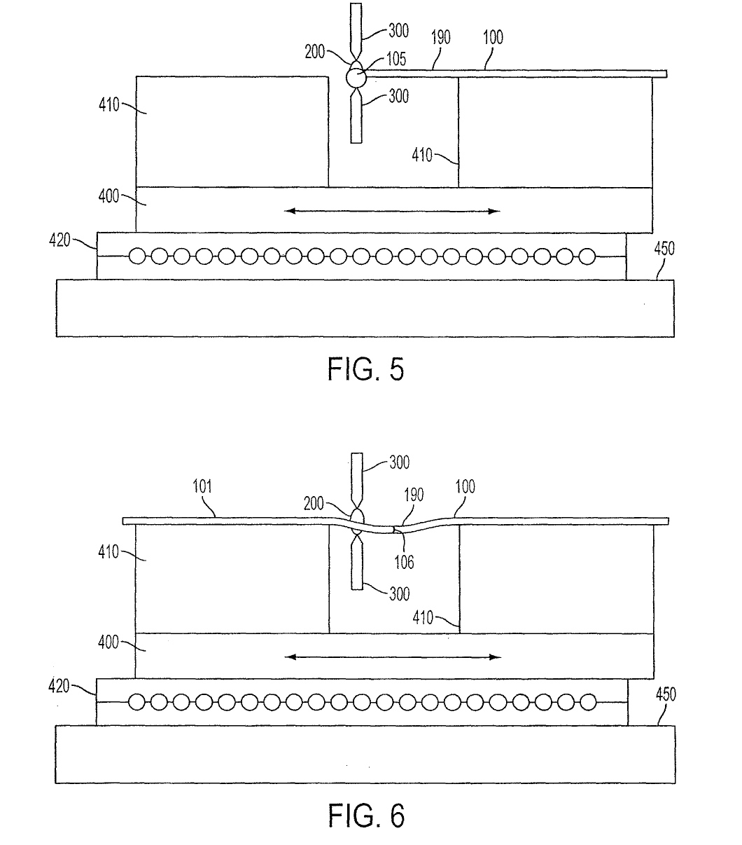

If the optical fiber 100 is held in a horizontal orientation during the heating as shown in FIG. 3, ball formed at the end of the optical fiber 100 may sag due to gravity. This is illustrated in the ball lens 105 at the end of the optical fiber 100 in FIG. 5.

In some cases, the sag of the ball lens 105 may be beneficial. For example, the sag results in some ball bending which may reduce the back-reflection from the ball end. On the other hand, if an application requires a straight optical axis and symmetric positioning of the ball lens 105, the ball sag may be undesirable.

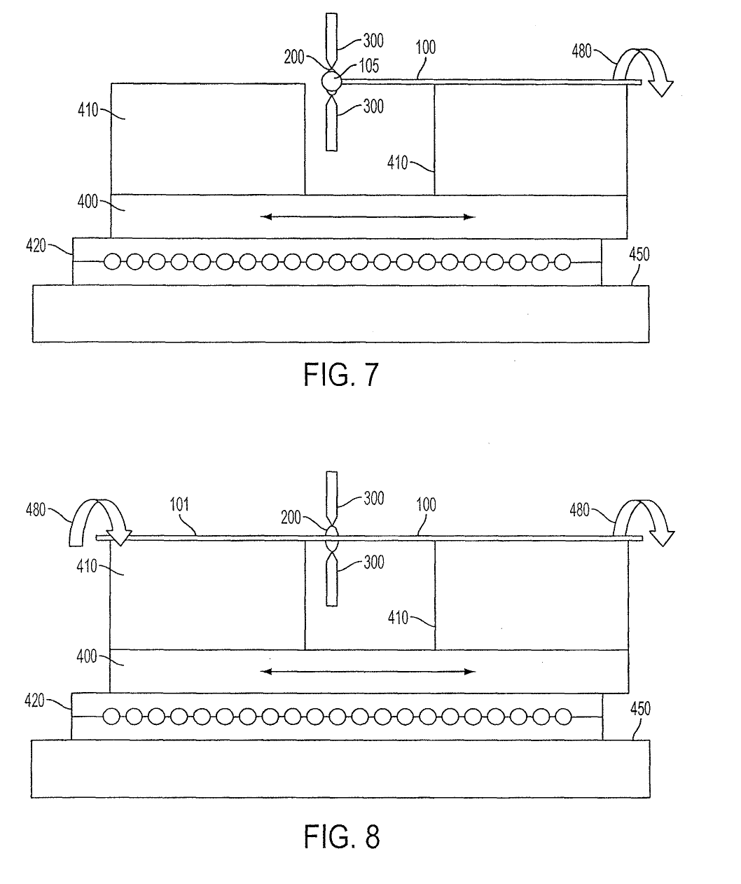

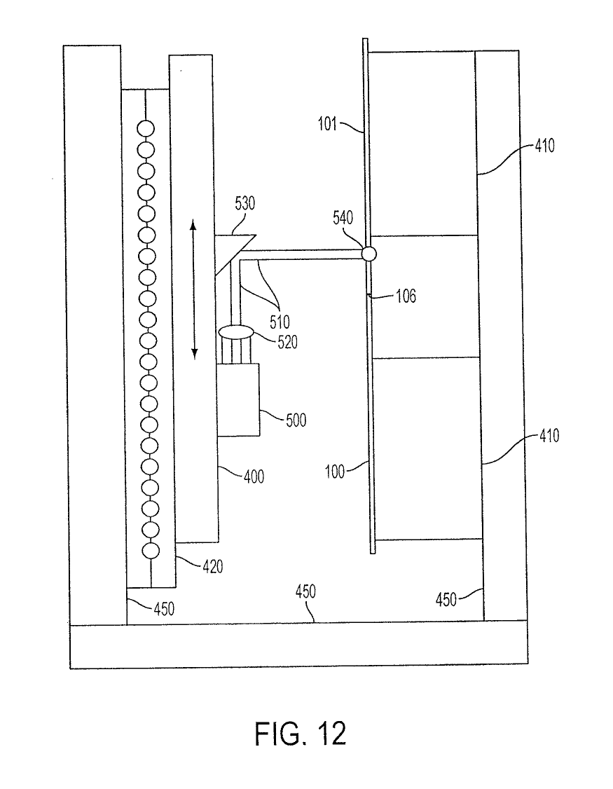

In another exemplary embodiment of the present invention, this sagging may be prevented by a method and apparatus in which the optical fiber 100 is rotated during the heating. As shown in FIG. 7, the optical fiber 100 is again held horizontally. In the exemplary embodiment shown in FIG. 7, the sagging of the ball may be prevented by rotating the optical fiber 100 in a circular direction 480 about its optical axis during the heating. If the optical fiber 100 is rotated while being heated, the gravitational effect will be balanced and counteracted. This may be accomplished by integrating rotation mechanisms into the clamp 410 which clamp the optical fiber 100. Additionally, the sagging may also be prevented by mounting the apparatus so that the fiber is fed into the heat source, i.e., arc discharge 200, in a vertical direction. FIG. 12 shows the apparatus of FIGS. 3, 5 and 7 mounted in this fashion.

When the optical fiber 100 is oriented vertically, the gravitational force is directed along the axis of the optical fiber 100 and there is no tendency for the ball at the end of the optical fiber 100 to sag with respect to the optical axis as it is heated. With the optical fiber mounted vertically, such as when the configuration of FIG. 3 is mounted as shown in FIG. 12, the movable translation stage 400 moves vertically and carries the clamp 410 and the optical fiber 100, thereby translating the end of optical fiber 100 vertically toward the electrodes 300 and into the heating field of the arc discharge 200. Once again, the movable translation stage 400 is attached to a bearing 420 and translated relative to a base 450 to which the electrodes 300 are affixed. Because gravity affects the ball formed at the end of optical fiber 100 uniformly along its optical axis, the sagging of the optical fiber 100 shown in FIG. 5 may be prevented.

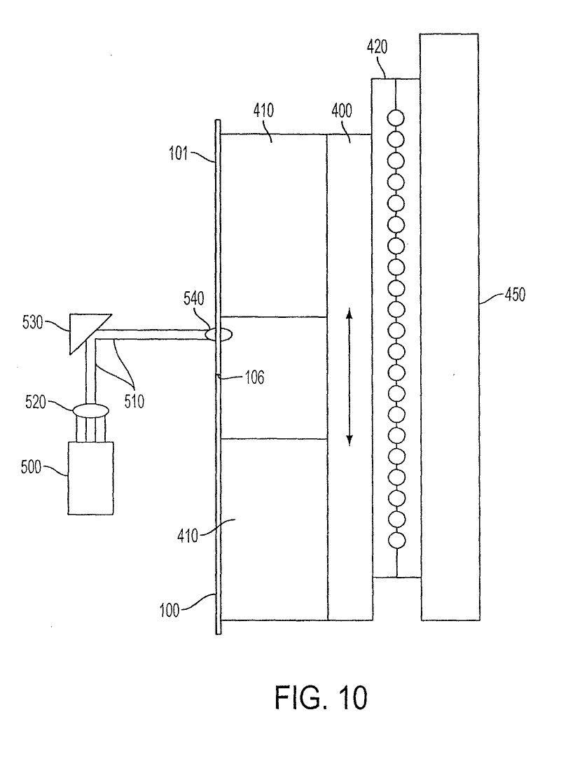

Any other suitable heat source may be used to heat the optical fiber 100 sufficiently to melt the end of the optical fiber 100 to form a ball lens 105. As shown in FIGS. 10 and 12, a laser 500 may be used in the apparatuses and methods described above as the heat source for melting the optical fiber 100 to form a ball lens 105 at the end of the optical fiber 100. In this case the laser beam 510 is shaped and controlled by optical elements such as a lens 520, and the laser beam 510 may be directed towards the optical fiber 100 by a mirror 530 so that the concentrated and focused optical fiber creates a heating area 540 which heats the end of the optical fiber 100.

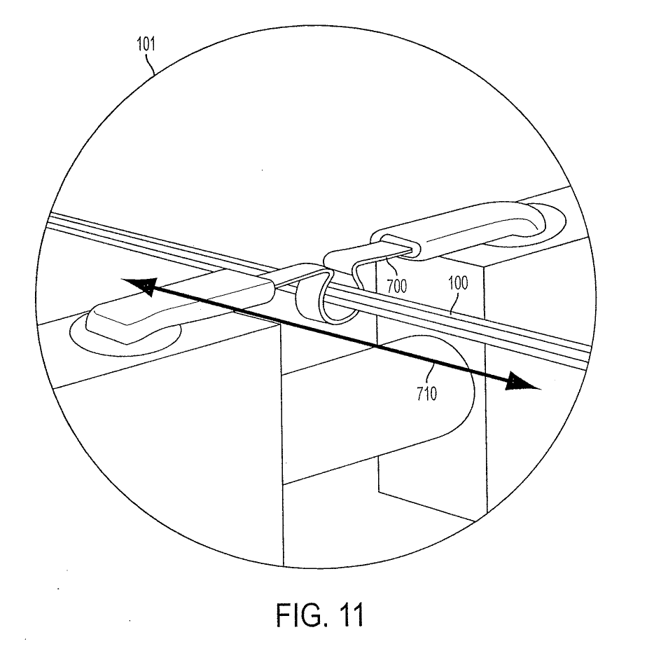

Alternatively, a gas flame may be used as the heat source to melt the optical fiber 100. Also, as shown in FIG. 11, a filament 700 may be used as the heat source to melt optical fiber 100. Such filaments have been employed for splicing optical fibers, as well as for other fiber-related tasks. For these applications, the filament is typically shaped like the Greek letter Omega and the optical fiber 100 is disposed to pass through the center of the filament 700 as shown in FIG. 14. If the end optical fiber 100 is translated along its optical axis in the direction 710 shown in FIG. 14 such that it passes through the filament 700, the end of the optical fiber 100 may be heated and a ball lens 105 formed.

Another exemplary embodiment of an apparatus for performing a method of the invention is shown in FIG. 12. In this case, the optical fiber 100 is held stationary with respect to the base 450 by the use a clamp 410, and the heat source is moved relative to the optical fiber 100. In the example shown in FIG. 12, the heat source is a laser 500 with a lens 520 and a mirror (530). The laser 500, the lens 520, and the mirror 530 are mounted to the movable translation stage 400 which is attached to a bearing 420. The bearing 420 allows motion relative to the base 450. Translation of the movable translation stage 400 therefore moves the laser 500, the lens 520, and the mirror 530 so that the laser beam 510 and the concentrated and focused heating area 540 scanned along the optical axis of to the end of the optical fiber 100.

An appropriate combination of heating power and conveying speed is different for different types and sizes of optical fibers. These parameters also vary based on the specifications of the heating apparatus used to perform the ball lens forming method described above.

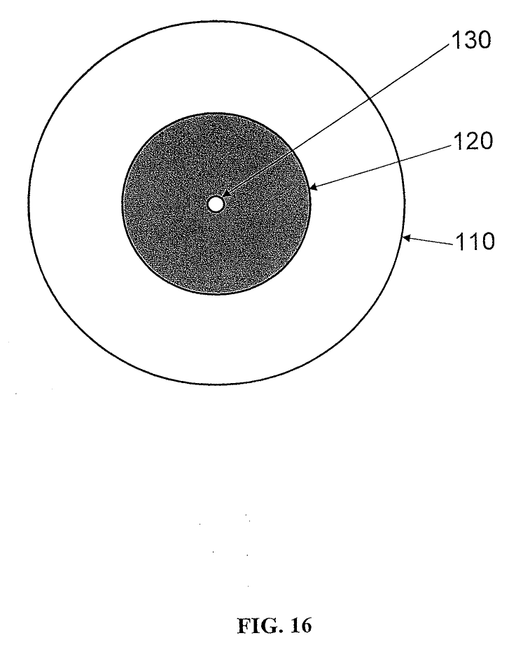

According to another exemplary embodiment, a method is provided for forming a ball lens which utilizes both a coreless optical fiber 101 and an optical fiber 100. A typical optical fiber for telecommunications use is shown in FIG. 16 and includes a core 130 surrounded by a cladding 120 that is surrounded by a protective coating 110. The cladding 120 is typically pure silica glass. The core 130 is typically doped with trace amounts of germania in order to raise the index of refraction of the core 130 relative to the cladding 120. The coating 110 is typically an acrylate plastic material that serves to protect the glass optical fiber from damage.

Consequently, when the typical optical fiber is melted to form a ball lens, the core material remains in the ball lens leading to an inhomogeneous ball lens material distribution. This may lead to poor focus control of the ball lens. As aspect of this embodiment is to utilize a coreless optical fiber 101 to form the ball lens 105 of a relatively homogeneous material distribution. As a result, a ball lens 105 can be formed which has improved focus control.

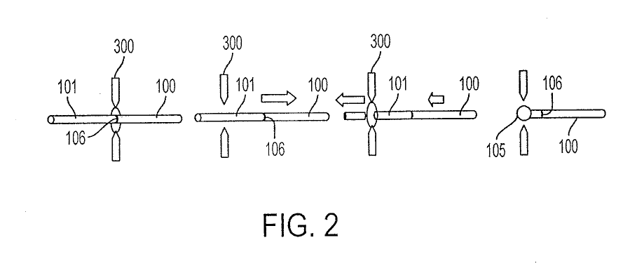

The ball lens 105 of this embodiment may be formed using the any of the methods set forth above. However, this embodiment differs in the initial preparation of the optical fiber. As shown in FIG. 2, the optical fiber is formed by splicing a coreless optical fiber 101 to another optical fiber 100. The optical fiber 100 may be of any configuration, i.e., an optical fiber having a core, a single clad optical fiber, a double clad optical fiber, etc. However, splicing would not be required if the optical fiber 100 is of the same configuration as the coreless optical fiber 101. Thus, according to this method a coreless optical fiber 101 is spliced to another optical fiber 100 using a heating source, such as an arc discharge formed by electrodes 300. After the splicing operation, a portion of the coreless optical fiber 101 positioned away from the splice point 106 and severed. The coreless optical fiber 101 may be severed using the arc discharge from the electrodes 300. The distance in which the severing occurs from the splice point 106 may correspond to the amount of fiber required to form the ball lens of a particular diameter. However, this length may be greater wherein a predetermined portion of the coreless optical fiber extends between the ball lens 105 and the splice point 106.

A ball lens 105 is then formed on the spliced optical fiber which includes a coreless optical fiber 101 and another optical fiber 100. The ball lens 105 may be formed by any of the methods and apparatuses described above by inserting the coreless optical fiber end of the spliced optical fiber into a heating zone generated by the arc discharge of electrodes 300.

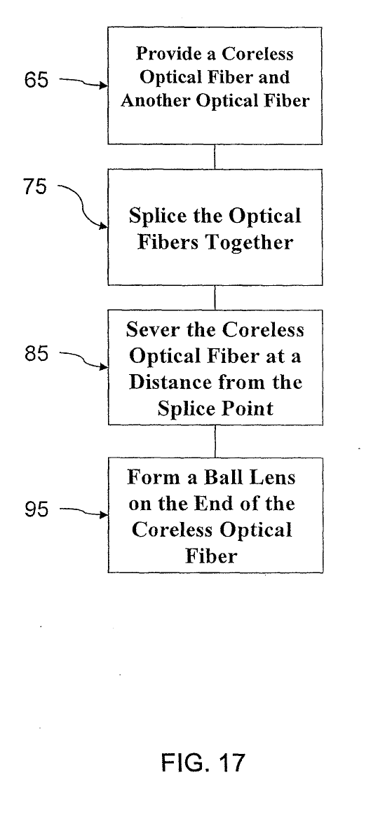

A method for making a ball lens according to this exemplary embodiment of the present invention is shown in FIG. 17. Both a coreless optical fiber 101 and another optical fiber 100 are provided in operation 65. Then the coreless optical fiber 101 is spliced to the other optical fiber 100 in operation 75. After the coreless optical fiber 101 is spliced to the other optical fiber 100, the spliced optical fiber is severed in the coreless optical fiber portion at a distance from the splice point 106 in operation 85. Finally, a ball lens is foamed on the coreless optical fiber end of the spliced optical fiber in operation 95. The ball lens 105 may be formed using any of the methods and apparatuses described above.

FIG. 4 an example of an apparatus for performing the method outlined above. As shown in FIG. 4, an arc discharge 200 is generated by a pair of fixed electrodes 300. The coreless optical fiber 101 placed adjacent to the other optical fiber 100 and heated using the arc discharge 200 for form a splice at the splice point 106 (shown to the right of the arc discharge in FIG. 4). In the apparatus shown in FIG. 4, two clamps 410 are used to clamp the coreless optical fiber 101 and the other optical fiber 100 on either side of the electrodes 300. The two clamps 410 are affixed to a movable translation stage 400. The movable translation stage 400 is mounted onto a bearing 420 which allows motion relative to a base 450. If the electrodes 300 are fixed to the base 450, the translation stage thereby moves the optical fiber 100 past the electrodes 300 and through the heating zone of the arc discharge 200. After the splicing operation is completed, the spliced optical fiber is moved to the right in FIG. 3 by a predetermined distance and the spliced optical fiber is severed in the coreless portion of the optical fiber using the heat source, i.e., arc discharge. Then, as set forth above with regard to FIGS. 4 and 7, a ball lens is formed on the coreless end of the spliced optical fiber.

If the optical fiber 100 is held in a horizontal orientation during the heating, the optical fiber 100 may sag due to gravity. This is illustrated by the sagging portion 190 of the optical fiber 100 in FIG. 6. If the optical fiber 100 sags and no longer has a straight optical axis, optical power carried by the optical fiber may be lost.

FIG. 8 shows a method of preventing the sagging problem described above. As shown in FIG. 8, the optical fiber 100 is held horizontally. Here, the sagging may be prevented by rotating the optical fiber 100 and the coreless optical fiber 101 in a circular direction 480 about its optical axis during the heating. If the optical fiber 100 is rotated while being heated, the gravitational effect will be balanced and counteracted. This may be accomplished by integrating rotation mechanisms into the two clamps 410 which clamp the optical fiber 100 and the coreless optical fiber 101.

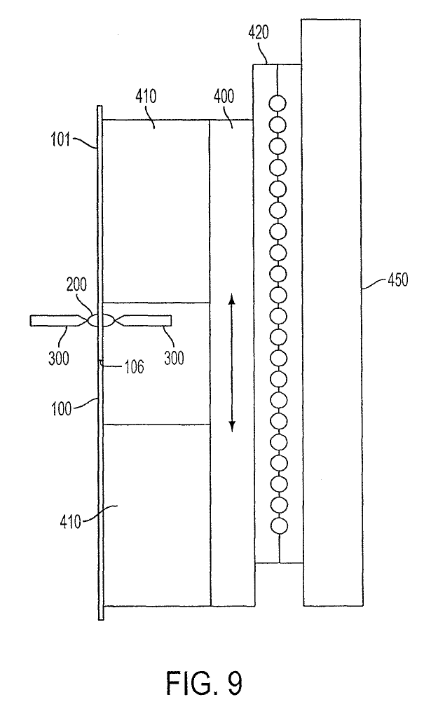

FIG. 9 shows another method of preventing the sagging problem described above. As shown in FIG. 9, the optical fiber 100 and the coreless optical fiber 101 may be oriented vertically. In this case the gravitational force is directed along the axis of the optical fibers and there is no tendency for the optical fibers to bend as they are heated. With the optical fiber mounted vertically as shown in FIG. 9, the movable translation stage 400 moves vertically and carries the two clamps 410, the optical fiber 100 and the coreless optical fiber 101, thereby translating the optical fibers vertically past the electrodes 300 and through the heating field of the arc discharge 200. Once again, the movable translation stage 400 is attached to a bearing 420 and translated relative to a base 450 to which the electrodes 300 are affixed. Because gravity affects the optical fibers uniformly along their optical axis, the sagging of the optical fibers may be prevented.

Any other suitable heat source may be used to heat the optical fibers sufficiently to form the splice and the ball lens. In another exemplary embodiment of the invention as shown in FIG. 103, a laser 500 is used as the heat source for splicing the coreless optical fiber 101 to the other optical fiber 100, and also forming the ball lens on the coreless end of the spliced optical fiber. In this case the laser beam 510 is shaped and controlled by optical elements such as a lens 520, and the laser beam 510 may be directed towards the optical fibers by a mirror 530 so that the concentrated and focused optical fiber creates a heating area 540 which heats the optical fibers.

Alternatively, a gas flame may be used as the heat source to round the optical fibers. Also, as shown in FIG. 11, a filament 700 may be used as the heat source to splice the optical fibers and form the ball lens. Such filaments have been employed for splicing optical fibers, as well as for other fiber-related tasks. For these applications, the filament is typically shaped like the Greek letter Omega and the optical fibers 100 are disposed to pass through the center of the filament 700 as shown in FIG. 11. If the optical fiber 100 is translated along its optical axis in the direction 710 shown in FIG. 11 such that is passes through the filament 700, a section of the optical fiber may be heated.

Another exemplary embodiment of the invention is shown in FIG. 12. In this case, the optical fibers are held stationary with respect to the base 450 by the use of two clamps 410, and the heat source is moved relative to the fiber. In the example shown in FIG. 12, the heat source is a laser 500 with a lens 520 and a mirror 530. The laser 500, the lens 520, and the mirror 530 are mounted to the movable translation stage 400 which is attached to a bearing 420. The bearing 420 allows motion relative to the base 450. Translation of the movable translation stage 400 therefore moves the laser 500, the lens 520, and the mirror 530 so that the laser beam 510 and the concentrated and focused heating area 540 are positioned along the optical axis of the optical fibers at the appropriate portions.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded into a computer or other programmable data processing apparatus to cause a series of operational steps to be performed in the computer or other programmable apparatus to produce a computer implemented process such that the instructions that execute in the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

Although a few exemplary embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for forming a ball lens comprising:
determining a feed length of optical fiber based on a target ball lens diameter;
providing heat energy to a heating zone;
moving, at a predetermined speed, one of the optical fiber and the heating zone so that the end of the optical enters the heating zone to heat the end of the optical fiber; and
stopping the heating of the end of the optical fiber when the amount of moving the one of the optical fiber and the heating zone equals the determined feed length.

2. The method of forming a ball lens according to claim 1, further comprising:
determining the predetermined speed based on an amount of heat energy provided and a diameter of the optical fiber.

3. The method of forming a ball lens according to claim 1, wherein the heat energy applied to the optical fiber melts the optical fiber to form a molten ball.

4. The method of forming a ball lens according to claim 1, wherein the heating is stopped by shutting off the heat energy.

5. The method of forming a ball lens according to claim 1, wherein the heating is stopped by removing the optical fiber from the heating zone.

6. The method of forming a ball lens according to claim 1, further comprising:
rotating the optical fiber during the heating of the end of the optical fiber.

7. An apparatus for forming a ball lens comprising:
an optical fiber heating apparatus that provides heat energy and conveys an optical fiber into a heating zone heated by the heat energy;
a parameter determination unit that determines a feed length of optical fiber based on a target ball lens diameter; and
an optical fiber heating apparatus controller that controls the optical fiber heating apparatus to heat the optical fiber and convey the optical fiber the determined feed length.

8. The apparatus for forming a ball lens according to claim 7, wherein the optical fiber is conveyed into the heating zone by moving the optical fiber into a stationary heating zone.

9. The apparatus for forming a ball lens according to claim 7, wherein the optical fiber is conveyed into the heating zone by moving heating zone onto a stationary optical fiber.

10. The apparatus for forming a ball lens according to claim 7, wherein the optical fiber heating apparatus is configured to rotate the optical fiber about an optical axis of the optical fiber.

11. The apparatus for forming a ball lens according to claim 7, wherein the optical fiber heating apparatus controller is configured to stop the heat energy when the optical fiber is conveyed the determined feed length.

12. A method for forming a ball lens comprising:
providing a coreless optical fiber and a second optical fiber different from the coreless optical fiber;
splicing the coreless optical fiber to the second optical fiber to form a spliced optical fiber;
severing the spliced optical fiber in a portion of the coreless optical fiber at a predetermine distance from a splice point of the spliced optical fiber;
determining a feed length of the spliced optical fiber based on a target ball lens diameter;
providing heat energy to a heating zone;
moving, at a predetermined speed, one of the spliced optical fiber and the heating zone so that the coreless end of the spliced optical fiber enters the heating zone to heat the end of the spliced optical fiber; and
stopping the heating of the end of the spliced optical fiber when the amount of moving the one of the spliced optical fiber and the heating zone equals the determined feed length.

13. The method of forming a ball lens according to claim 12, further comprising:
determining the predetermined speed based on an amount of heat energy provided and a diameter of the spliced optical fiber.

14. The method of forming a ball lens according to claim 12, wherein the heat energy applied to the spliced optical fiber melts the spliced optical fiber to form a molten ball.

15. The method of forming a ball lens according to claim 12, wherein the heating is stopped by shutting off the heat energy.

16. The method of forming a ball lens according to claim 12, wherein the heating is stopped by removing the optical fiber from the heating zone.

17. The method of forming a ball lens according to claim 12, further comprising:
rotating the optical fiber during the heating of the end of the spliced optical fiber.

18. An optical fiber having a ball lens, comprising:
an spliced optical fiber including a coreless optical fiber spliced to a second optical fiber; and
a ball lens attached to the coreless optical fiber,
wherein the ball lens is formed of the same material as the coreless optical fiber.

19. The optical fiber having a ball lens according to claim 18, wherein the second optical fiber has a core.
